(19) United States
(12) Patent Application Publication
(10) Pub. No.: US 2007/0125079 A1
(43) Pub. Date: Jun. 7, 2007

(54) Buoyancy propulsion air and water transfer system

(76) Inventor: Myron Lieberman, Miami Beach, FL (US)

Correspondence Address: Wilson Daniel Swayze, Jr, 3804 Clearwater Ct., Plano, TX, 75025, US

(21) Appl. No.: 11/295,970

(22) Filed: Dec. 7, 2005

(51) Int. Cl. F03B 17/02

(52) U.S. Cl. 60/495

(57) ABSTRACT

An apparatus to generate electricity in a fluid includes a hollow objects or bladders to move along a path, a magnetic rail/track system to carry the hollow objects or bladders along the path, a first fill apparatus to fill the hollow objects or bladders with air/gas at a first position on the path, a drain apparatus to drain the hollow objects or bladders of the air/gas at a second position on the path, a fill hollow objects or bladders with liquid.

### FIELD OF THE INVENTION

The present invention relates to gravity and buoyancy driven power generating units.

### BACKGROUND OF THE INVENTION

There is a general need for alternate sources of power which are inexpensive to operate, are efficient in operation, pollution free and needs no outside source of fuel to operate. Prior art power generators tend to be highly inefficient and can lose a great deal of power due to these inefficiencies before that power can be utilized.

The prior art includes several examples of machines that utilize buoyancy. One such prior art device is disclosed in the Kusmer patent, U.S. Pat. No. 3,412,482 which discloses a buoyancy demonstrating apparatus having an number of expandable and compressible gas chambers provided around the periphery of an endless carrier which is in immersed in water. Another is the Tatay patent, U.S. Pat. No. 1,708,807 which discloses an air and water power driven device which utilizes a number of floats which are mounted on a continuous chain and which pass through a tube of water in order to provide motion. The patent to Willmouth, U.S. Pat. No. 4,718,232 discloses an apparatus that includes a long chain having hollow buoyancy elements in which the chain extends around a pair of sprockets.

### SUMMARY OF THE INVENTION

The present invention relates to an apparatus that generates electric power from the forces of gravity and buoyancy, utilizing hollows bodies immersed in a fluid, and at a specific position change the hollow objects from buoyant to un-buoyant states, and back to buoyant at a certain position in its travels. It is an object of the present invention to convert buoyancy and gravity of all the objects into a useful source of electric power. Again, the present invention utilizes gravity and buoyancy to generate electric power.

### BRIEF DESCRIPTION OF THE DRAWINGS

The present invention may be understood by reference to the following description taken in conjunction with the accompanying drawings, in which, like reference numerals identify like elements, and in which:

FIG. 1 illustrates a cross-sectional view of the system of the present invention;

FIG. 2 illustrates a cross-sectional view of a hollow object of the present invention;

FIG. 3 illustrates a cross-sectional view of another hollow object of the present invention.

### DETAILED DESCRIPTION

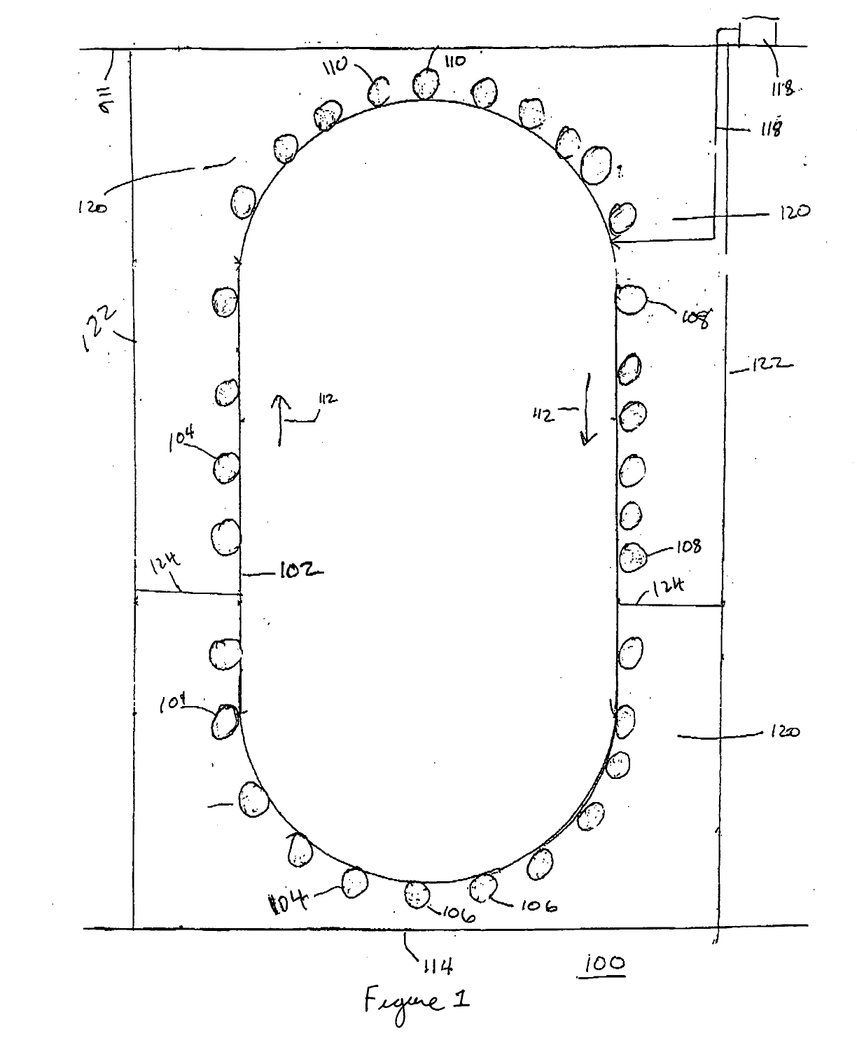

FIG. 1 illustrates the buoyancy propulsion air and water transfer system 100 of the present invention. The system 100 includes a magnetic rail/track system 102 to define a path for moving copper coiled hollow objects or bladders 104, 106, 108 and 110 which are the copper coiled hollow objects or bladders. The magnetic rail/track system 102 is shown in the shape of an oval, yet other shapes including circular and rectangular with curved corners are within the scope of the invention. The magnetic rail/track system 102 holds and transports the copper coiled hollow objects or bladders 104, 106, 108 and 110 around the magnetic rail/track system 102 and provides communication with the copper coiled hollow objects or bladders 104, 106, 108 and 110 to remove fluid which may be water from the copper coiled hollow objects or bladders 104, 106, 108 and 110 and pressurize the copper coiled hollow objects or bladders 104, 106, 108 and 110 with air or gas for ascent. Additionally, the magnetic rail/track system 102 produces electricity as part of the turbine system to the end users of the buoyancy propulsion air and water transfer system 100. FIG. 1 illustrates first transition of a copper coiled hollow object which is purging its fluid from the transition copper coiled hollow object, (if a bladder is employed, no fluid would be in the bladder to purge) 106 to the fluid 120 around the system 100 and the first transition copper coiled hollow object or bladder 106 is receiving pressurized air or gas for ascent (just purging the fluid from a copper coiled hollow object would make it buoyant and filling a bladder with air/gas would make it buoyant). The pressurized copper coiled hollow object or bladder 104 has been substantially filled with pressurized air or gas so that the buoyancy of the pressurized copper coiled hollow object or bladders 104 moves the copper coiled hollow objects or bladders in direction 112 along the magnetic rail/track system 102 from substantially the bottom of the magnetic rail/track system 100 to the top of the magnetic rail/track system 100. The second transition copper coiled hollow object or bladder 110 is in transition by expelling the air/gas from the second transition copper coiled hollow object or bladder 110 and filling the second transition copper coiled hollow object or bladder 110 with fluid. The fluid filled copper coiled hollow object or bladder 108 travels from substantially the top of the magnetic rail/track system 100 to the bottom of the magnetic rail/track system 100, thus completing a revolution of the magnetic rail/track system 100. The air transfer system 118 communicates with the magnetic rail/track system 102 so that the copper coiled hollow object system or bladder 104, 106, 108 and 110 can be drained or filled with either fluid or air/gas at the appropriate position of the system 100. FIG. 1 shows the magnetic rail/track system moving in the counterclockwise direction 112; however, the magnetic rail/track system 100 could move in the opposite clockwise direction. FIG. 1 additionally shows the structural support 122 adjacent to the path of travel of the magnetic rail/track system 100 along with machine to wall support 124 to support the magnetic rail/track system 100. It could be supported in any manner and position that could be more effective, the bottom of the fluid 114 and a surface of the fluid 116. 118 is the air/water transfer. 120 is the body of water (fluid).

FIG. 1 illustrates a directional turbine which includes a stationary magnetic rail/track 102 which could be positioned on the inner or outer part of the machine and the rotating copper coiled hollow object 104 which includes coils to generate electricity as a result of the movement of the inner or outer rail track system as it circles/rotates around a stationary inner or outer magnetic rail/track system. The directional turbine includes a magnet to generate magnetic flux 102. As the directional turbine moves along the magnetic rail/track 102, the magnetic flux 102 interacts with the rail/track 102 to generate electricity as a result of the movement with the copper coiled hollow objects 104, 106, 108 and 110 which moves as a result of buoyancy and gravity, and electricity is transmitted to the user by the magnetic rail/track 102 or any other feasible method. The inner or outer magnetic rail/track system 102 can be the power energy forces (buoyancy and gravity) driving the magnetic rail/track system, as long as the inner rail/track system is the magnetic field and the outer part of the magnetic rail/track system are the electric copper coiled hollow objects, or any variation of the above.

The system 100 of the present invention is designed to be in continual motion; either the inner or outer part of the rail/track system is either the magnetic field or the copper coils that are necessary to produce electricity. The rail/track system 102 could be one or four rails or tracks, which could also serve as the copper coil part of the directional turbine or the magnetic part of the system. The four rails would hold the hollow objects or bladders as a guiding pathway for them.

The rail/track system 100 may be used in any body of water as long as there is sufficient depth for the magnetic rail/track system to operate, and also in a man made hole in the ground, like a silo or a giant container specially designed and constructed to house this magnetic rail/track system 100. The copper coiled hollow objects or bladders may be filled with compressed air or gas for buoyancy. When the hollow objects or bladders gets to the top of the rail/track system 100, the air or gas is released from inside the hollow objects or bladders, and when the hollow objects starts to descend on the downward side of the rail/track system, the hollow objects are filled with a fluid (water), bladders may or may not be filled with a fluid Whichever way works best under the circumstances, will be utilized.

As a consequence there is no or little resistance to the hollow objects or bladders as they descend because they have lost their buoyancy.

As the hollow objects or bladders reaches the bottom of the rail/track system 100, the hollow objects or bladders are filled with air or gas which may be accomplished by pump, hydraulics, a trip mechanism or a ring type piston device in the hollow objects or any other suitable method. The magnetic rail/track system 100 which is the directional turbine can be any rounded shape as long as the hollow objects can move in a train like situation as part of the directional turbine which both makes up the complete system.

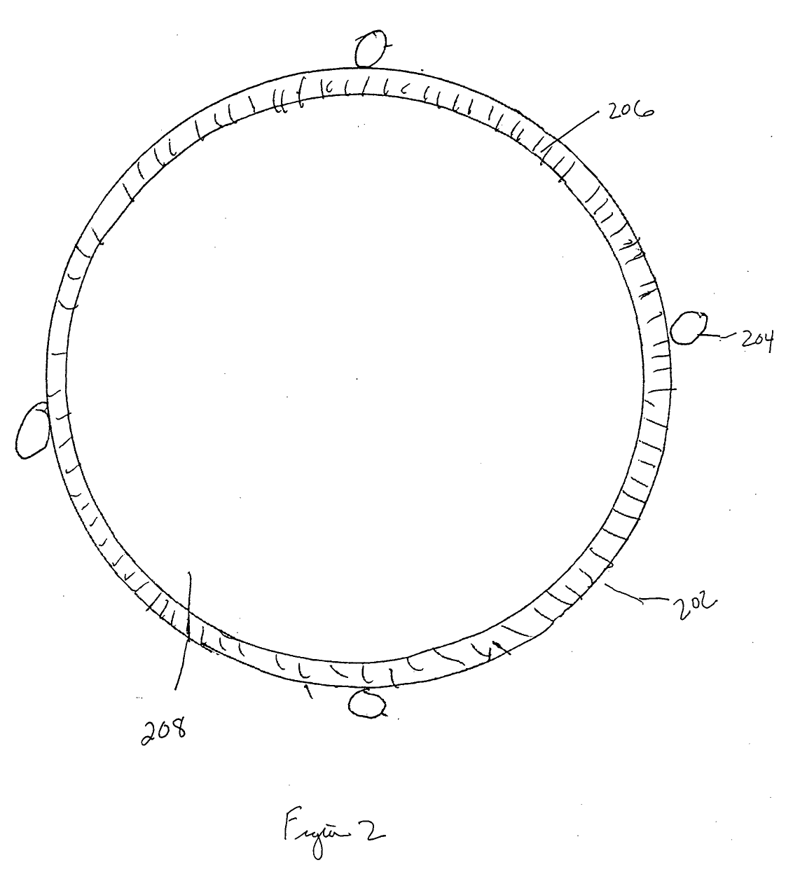

FIG. 2 illustrates a hollow object 202 which includes coils 206 which may be copper, a magnetic rail/track system 204 and a hollow area 208 of the hollow object. A stationary rail/track 204 which could be positioned on the inner or outer part of the machine and the rotating hollow object 202 which includes coils to generate electricity as a result of the movement of the inner or outer rail track system as it circles/rotates around a stationary inner or outer rail/track system.

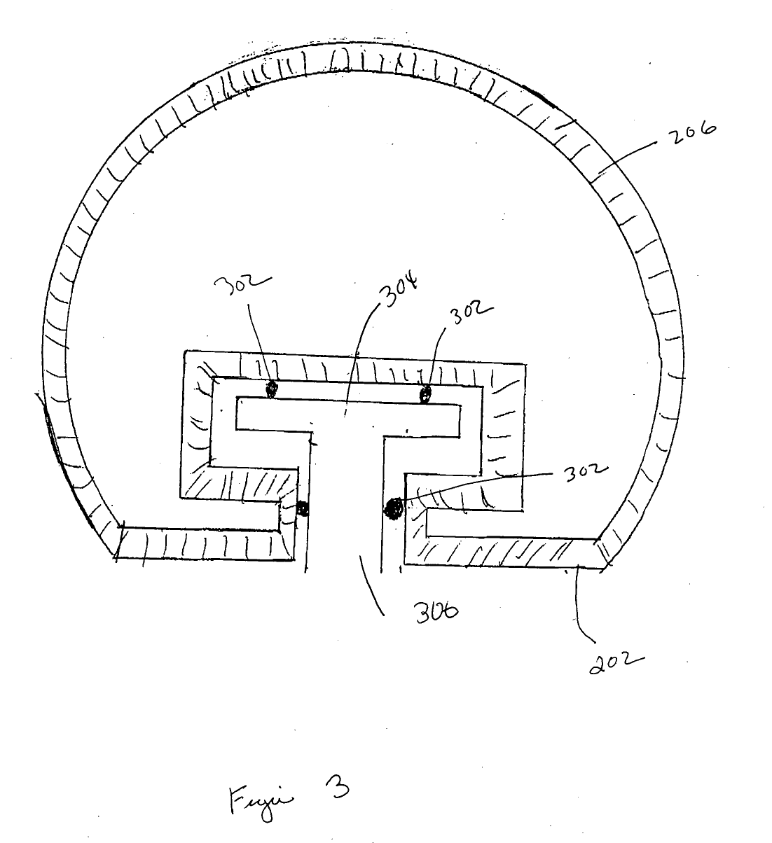

As shown in FIG. 3, the hollow object 202 includes a magnet 304 to generate magnetic flux, wheels 304 for the hollow object and a support 306 for the magnetic rail/track system. As the hollow object 202 moves along the magnetic rail/track 204, the magnetic flux interacts with the coils 206 to generate electricity as a result of the movement of the hollow object 104, 106, 108 and 110 which moves as a result of buoyancy and gravity, and electricity is transmitted to the user by the magnetic rail/track 204. The inner or outer magnetic rail/track system 204 can be the power energy forces (buoyancy and gravity) driving the magnetic rail/track system, as long as the inner magnetic rail/track system is the magnetic field and the outer part of the magnetic rail/track system are the electric copper coils, or any variation of the above.

While the invention is susceptible to various modifications and alternative fonts, specific embodiments thereof have been shown by way of example in the drawings and are herein described in detail. It should be understood, however, that the description herein of specific embodiments is not intended to limit the invention to the particular forms disclosed.

1) An apparatus to generate electricity in a fluid, comprising:
a hollow object to move along a path;
a magnetic rail/track system to carry said hollow object along said path;
a first fill apparatus to fill said hollow object with a air/gas at a first position on said path;
a drain apparatus to drain said hollow object of said air/gas at a second position on said path.

2) An apparatus to generate electricity in a fluid as in claim 1, wherein said apparatus includes a second fill apparatus to fill said hollow object with said liquid.

3) An apparatus to generate electricity in a fluid as in claim 1, wherein said hollow object is a bladder.

4) An apparatus to generate electricity in a fluid as in claim 1, wherein said magnetic rail/track system is oval in shape.

5) An apparatus to generate electricity in a fluid as in claim 1, wherein said magnetic rail/track system is substantially rectangular with rounded corners.

6) An apparatus to generate electricity in a fluid as in claim 1, wherein said apparatus includes a directional turbine to generate said electricity and is movable so that said directional turbine can remain positioned toward said path.

7) An apparatus to generate electricity in a fluid as in claim 6, wherein said directional turbine is one of the inner or outer part of the magnetic rail/track system.

8) A method to generate electricity in a fluid, comprising the steps of:
Moving one of a hollow object or a bladder along a path;
carrying said hollow object or bladder on a magnetic rail/track system along said path:
filling said hollow object or bladder with gas at a first position on said path;
draining said one of said hollow object or said bladder of gas at a second position along said path.

9) A method to generate electricity in a fluid as in claim 8, wherein said method includes the step of filling said hollow object with said liquid.

10) A method to generate electricity in a fluid as in claim 8, wherein said object is a bladder.

11) A method to generate electricity in a fluid as in claim 8, wherein said magnetic rail/track system is oval in shape.

12) A method to generate electricity in a fluid as in claim 8, wherein said magnetic rail/track system is substantially rectangular with rounded corners.

13) A method to generate electricity in a fluid as in claim 8, wherein said method includes the step of generating said electricity with a directional turbine.

14) A method to generate electricity in a fluid as in claim 13, wherein said directional turbine ii part of the magnetic rail/track system.
